(19) United States
(12) Patent Application Publication
(10) Pub. No.: US 2025/0247618 A1
(43) Pub. Date: Jul. 31, 2025

(54) OPTICAL-ELEMENT DRIVE APPARATUS AND OPTICAL APPARATUS

(71) Applicant: CANON KABUSHIKI KAISHA, Tokyo (JP)

(72) Inventor: YOSHIKAZU ASAI, Kanagawa (JP)

(21) Appl. No.: 19/012,284

(22) Filed: Jan. 7, 2025

(30) Foreign Application Priority Data
Jan. 29, 2024 (JP) 2024-010855

(51) Int. Cl. H04N 23/68; H04N 23/54

(52) U.S. Cl. CPC H04N 23/687; H04N 23/54

(57) ABSTRACT

An optical-element drive apparatus includes a fixed member fixed to a body of an optical apparatus, a movable unit holding an optical element and movable in a first direction relative to the fixed member, and an actuator configured to drive the movable unit in the first direction relative to the fixed member. The movable unit includes a first movable member holding the optical element, a second movable member coupled to the first movable member and configured to receive a driving force from the actuator, and an adjusting mechanism configured to perform position adjustment for the first movable member relative to the second movable member in a second direction orthogonal to the first direction.

### BACKGROUND

### Technical Field

The present disclosure relates to an optical-element drive apparatus that moves an optical element for purposes such as image stabilization.

### Description of Related Art

An optical apparatus is mounted with an optical-element drive apparatus that moves (shifts) an optical element such as an image sensor or a lens relative to the optical axis of an imaging optical system to reduce image blur due to vibration such as manual shake and assist tracking of moving bodies in panning imaging. In the optical-element drive apparatus, a movable unit including the optical element is driven relative to a fixed member, which is fixed to the body of the optical apparatus, by an actuator such as a voice coil motor (VCM).

In such an optical-element drive apparatus, the position of the optical element in the optical axis direction may be adjustable. Japanese Patent Laid-Open No. 2021-144165 discloses an optical-element drive apparatus including an adjusting mechanism that adjusts the position (flange back from a flange surface) of an imaging surface of an image sensor by integrally moving a fixed member and a movable unit holding the image sensor.

A structure that integrally moves the fixed member and the movable unit results in an increase in the size of the optical-element drive apparatus including the adjusting mechanism.

Furthermore, in a case where the image sensor is held by the movable unit with the imaging surface being tilted relative to a plane orthogonal to the optical axis due to manufacturing error, the tilts of the fixed member and the movable unit is to be adjusted by the above adjusting mechanism so that the imaging surface is parallel to the plane orthogonal to the optical axis. However, variations in the flange back increase in a case where the movable unit is driven in a state in which the fixed member is tilted relative to the plane orthogonal to the optical axis through the tilt adjustment.

### SUMMARY

An optical-element drive apparatus according to one aspect of the disclosure includes a fixed member fixed to a body of an optical apparatus, a movable unit holding an optical element and movable in a first direction relative to the fixed member, and an actuator configured to drive the movable unit in the first direction relative to the fixed member. The movable unit includes a first movable member holding the optical element, a second movable member coupled to the first movable member and configured to receive a driving force from the actuator, and an adjusting mechanism configured to perform position adjustment for the first movable member relative to the second movable member in a second direction orthogonal to the first direction. An optical apparatus having the above optical-element drive apparatus also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram illustrating the configuration of an image pickup apparatus including a sensor drive apparatus according to a first embodiment.

FIG. 2 is a perspective view illustrating the front appearance of the image pickup apparatus according to the first embodiment.

FIG. 3 is a perspective view illustrating the rear appearance of the image pickup apparatus according to the first embodiment.

FIG. 4 is an exploded perspective view illustrating the internal structure of the image pickup apparatus according to the first embodiment when viewed from the rear surface side.

FIG. 5 is an exploded perspective view of the sensor drive apparatus according to the first embodiment when viewed from the front surface side.

FIG. 6 is an exploded perspective view of a movable unit of the sensor drive apparatus according to the first embodiment when viewed from the front surface side.

FIG. 7 is an exploded perspective view of the movable unit of the sensor drive apparatus according to the first embodiment when viewed from the rear surface side.

FIG. 8 is a cross-sectional view of a coupling portion of first and second movable members in the sensor drive apparatus according to the first embodiment.

FIGS. 9A to 9C are schematic diagrams illustrating changes in flange back in the sensor drive apparatus according to the first embodiment.

FIG. 10 is an exploded perspective view illustrating the internal structure of an image pickup apparatus according to a second embodiment.

FIGS. 11A to 11C are a rear view and cross-sectional views illustrating the internal structure of the image pickup apparatus according to the second embodiment.

FIGS. 12A to 12C are schematic diagrams illustrating change in flange back in the conventional sensor drive apparatus.

### DETAILED DESCRIPTION

Embodiments of the present disclosure will be described below with reference to the accompanying drawings.

### First Embodiment

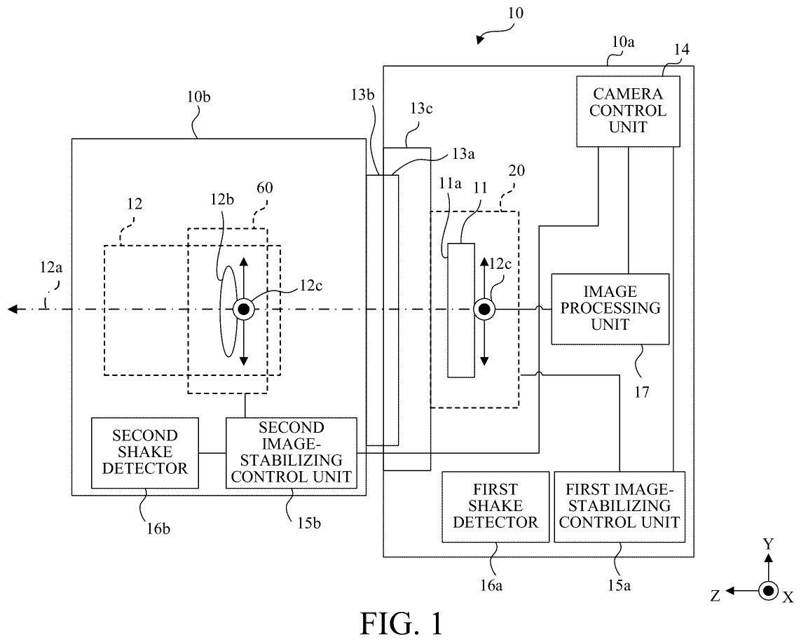

FIG. 1 illustrates the configuration of a camera system 10. The camera system 10 includes an image pickup apparatus (referred to as a camera hereinafter) 10a as an optical apparatus including an optical-element drive apparatus (an image stabilizing apparatus that drives an image sensor (sensor image-stabilizing apparatus hereinafter) 20 according to a first embodiment of the present disclosure, and an interchangeable lens 10b attached to and detachable from the camera 10a. The camera 10a is a mirrorless digital camera without a quick-return mirror and includes an image sensor 11, a base member 13c, a mount member 13a, a camera control unit 14, a first image-stabilizing control unit 15a, a first shake detector 16a, an image processing unit 17, and the sensor image-stabilizing apparatus 20. The interchangeable lens 10b as another optical apparatus includes an imaging optical system 12, a mount member 13b, a second image-stabilizing control unit 15b, a second shake detector 16b, and an image stabilizing apparatus that drives a correction lens (lens image-stabilizing apparatus hereinafter) 60 as an optical-element drive apparatus. The imaging optical system 12 includes a plurality of unillustrated lens units and includes a correction lens 12b.

In the following description, the central axis of the imaging optical system 12 will be referred to as an optical axis 12a, and a Z direction that is a direction in which the optical axis 12a extends will be referred to as an optical axis direction (second direction). An X direction (horizontal direction) and a Y direction (vertical direction) orthogonal to the optical axis 12a and orthogonal to each other will be collectively referred to as a shift direction (first direction), and an XY plane orthogonal to the optical axis 12a will be referred to as a shift plane 12c.

The optical axis 12a extends through the center of an imaging surface 11a of the image sensor 11 and is orthogonal to the imaging surface 11a in a non-operating state of the sensor image-stabilizing apparatus 20. The image sensor 11 as an optical element includes a photoelectric conversion element such as a CMOS sensor or a CCD sensor and includes a plurality of pixels on the imaging surface 11a. The image sensor 11 photoelectrically converts (captures) an object image (optical image) formed on the imaging surface 11a through the imaging optical system 12 and outputs an imaging signal. The imaging signal receives various processing in the image processing unit 17 and is converted into image data. The image data is stored in an unillustrated memory (storage medium).

The base member 13c constitutes a chassis of the camera 10a. The mount member 13a and the sensor image-stabilizing apparatus 20 (its fixed member to be described later) are fixed to the base member 13c, and the mount member 13a is connected to the mount member 13b of the interchangeable lens 10b. This enables communication between the camera 10a and the interchangeable lens 10b. The Sensor image-stabilizing apparatus 20 (its movable unit to be described later) holds the image sensor 11 in a manner that allows movement in the shift direction.

The Sensor image-stabilizing apparatus 20 moves (translates; hereinafter, shifts) the image sensor 11 in the shift direction and rotates the image sensor 11 in a plane parallel to the imaging surface 11a, thereby reducing (correcting) image blur caused by a shake to the camera 10a due to manual shake or the like. The first shake detector 16a includes a gyro sensor, an acceleration sensor, or the like, detects a shake of the camera 10a, and outputs a shake detection signal. The first image-stabilizing control unit 15a controls an actuator to be described later in the sensor image-stabilizing apparatus 20 based on the shake detection signal from the first shake detector 16a, thereby translating or rotating the image sensor 11. The image sensor 11 may be moved in the optical axis direction during translation of the image sensor 11.

The camera control unit 14 includes a computer including a CPU and the like and controls the overall operation of the camera system 10 by receiving a user input through an unillustrated operation unit.

The lens image-stabilizing apparatus 60 shifts (translates) the correction lens 12b as an optical element in the shift direction and rotates the correction lens 12b about its optical axis, thereby correcting image blur caused by shakes to the interchangeable lens 10b due to manual shake or the like. The second shake detector 16b includes a gyro sensor, an acceleration sensor, or the like, detects a shake of the interchangeable lens 10b, and outputs a shake detection signal. The second image-stabilizing control unit 15b controls an actuator in the lens image-stabilizing apparatus 60 based on the shake detection signal from the second shake detector 16b, thereby translating or rotating the correction lens 12b. The correction lens 12b may be moved in the optical axis direction during translation of the correction lens 12b. The interchangeable lens 10b does not necessarily need to include the lens image-stabilizing apparatus 60, the second shake detector 16b, or the second image-stabilizing control unit 15b.

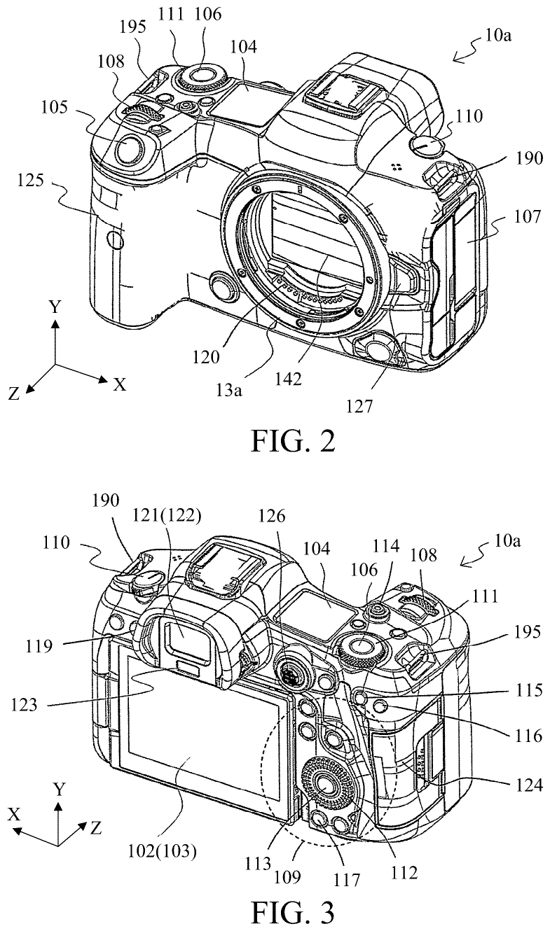

FIGS. 2 and 3 illustrate the appearance of the camera 10a, on which the interchangeable lens 10b is not mounted, when viewed from the front surface side (object side) and the rear surface side, respectively. The camera 10a includes a display unit 102, a touch panel 103, an extra-finder display unit 104, a shutter button 105, a mode switch 106, a terminal cover 107, a main electronic dial 108, a rear operation unit 109, a power switch 110, and a sub electronic dial 111. The camera 10a also includes a selection member 126, a moving image button 114, an auto-exposure (AE) lock button 115, an enlargement button 116, a playback button 117, a menu button 119, an eyepiece 121, an eye proximity detector 123, a lid 124, a grip portion 125, and a lock button 127.

The display unit 102 is a display device such as an LCD provided on the rear surface of the camera 10a and displays images and various kinds of information. The touch panel 103 is disposed on a display surface of the display unit 102 and detects touch operations on the display surface (operation surface). The extra-finder display unit 104 is provided on the upper surface of the camera 10a and displays various set values such as a shutter speed and an aperture value (F-number). The shutter button 105 is an operation member operable by a user to instruct imaging. The mode switch 106 is an operation member operable by the user to switch between imaging modes.

The terminal cover 107 is a member that protects an unillustrated connector to which a cable or the like connecting the camera 10a to an unillustrated external device is coupled. The main electronic dial 108 is an operation member that is rotationally operable by the user to change a set value such as a shutter speed and an aperture value, or the like. The power switch 110 is an operation member operable by the user to switch between power-on and power-off of the camera 10a.

The sub electronic dial 111 is an operation member operable by the user to move a selection frame that selects an area for autofocus (AF) and photometry (light metering), feed images displayed on the display unit 102, and the like. The rear operation unit 109 is provided on the rear surface of the camera 10a. The rear operation unit 109 includes a plurality of press buttons, a set button 113, and a rear surface dial 112. The rear surface dial 112 is an operation member operable by the user to change a set value such as a shutter speed and an aperture value, or the like. The set button 113 is a press button operable by the user to mainly determine a selected item and the like. The selection member 126 is a cross (four-direction) key operable by pressing parts corresponding to up, down, right, and left, respectively, thereby causing the camera 10a to execute a function in accordance with a pressed part.

The moving image button 114 is an operation member operable by the user to instruct to start and stop capturing a moving image. The AE lock button 115 is an operation member operable by the user to fix the exposure state in an imaging standby state. The enlargement button 116 is an operation member operable by the user to turn on and off an enlargement mode while a live-view (LV) image is displayed on the display unit 102 in an imaging mode. The LV image can be enlarged and reduced by operating the main electronic dial 108 after turning on the enlargement mode. In a playback mode, the enlargement button 116 is operated to increase the magnification of a playback image displayed on the display unit 102.

The playback button 117 is an operation member operable by the user to switch between the imaging mode and the playback mode. In a case where the playback button 117 is pressed down in the imaging mode, the camera control unit 14 transitions the operation mode to the playback mode and displays, on the display unit 102, a played back image in accordance with latest image data among image data stored in the unillustrated memory. The menu button 119 is an operation member operable by the user to display a menu screen on the display unit 102 during various settings. The user can intuitively perform various settings by using the menu screen displayed on the display unit 102, the rear surface dial 112, and the set button 113.

The user can visually recognize a LV image or playback image displayed on an EVF 122 provided in the camera 10a through the eyepiece 121 provided on an eyepiece (view) finder (peep-type finder). The eye proximity detector 123 is a sensor that detects whether an eye of the user is proximate to the eyepiece 121. The lid 124 is an openable member for protecting a slot in which an unillustrated memory is mounted.

The grip portion 125 is a site where the user grips with their right hand in a case where the user holds the camera system 10. The shutter button 105 and the main electronic dial 108 are disposed at positions operable with the forefinger of the right hand in a state in which the user grasps the camera 10a by holding the grip portion 125 with the little finger, ring finger, and middle finger of the right hand. The sub electronic dial 111 and the selection member 126 are disposed at positions where they can be operated with the thumb of the right hand in the same state.

The image sensor 11 includes a 35 mm full-frame CMOS sensor having an effective area of 24 mm×36 mm, for example, as the above-described photoelectric conversion element. The mount member 13a is a structural member through which the interchangeable lens 10b is coupled to the camera 10a. A communication terminal 120 for communications between the camera 10a and the interchangeable lens 10b is provided inside the mount member 13a. As the interchangeable lens 10b, not only a lens (full-frame compatible lens) through which exposure is possible on the entire effective area of the full-frame image sensor 11 but also a lens (for example, APS-C compatible lens) in a format with small exposure area can be mounted on the camera 10a.

When the interchangeable lens 10b is mounted on the camera 10a, an unillustrated lock mechanism holds (locks) the interchangeable lens 10b. The lock is released when the user presses down the lock button 127 so that the interchangeable lens 10b can be detached from the camera 10a. Strap passage portions 190 and 195 through which a strap or similar cord-like member (not illustrated) for portability can pass are provided at two places of the camera 10a.

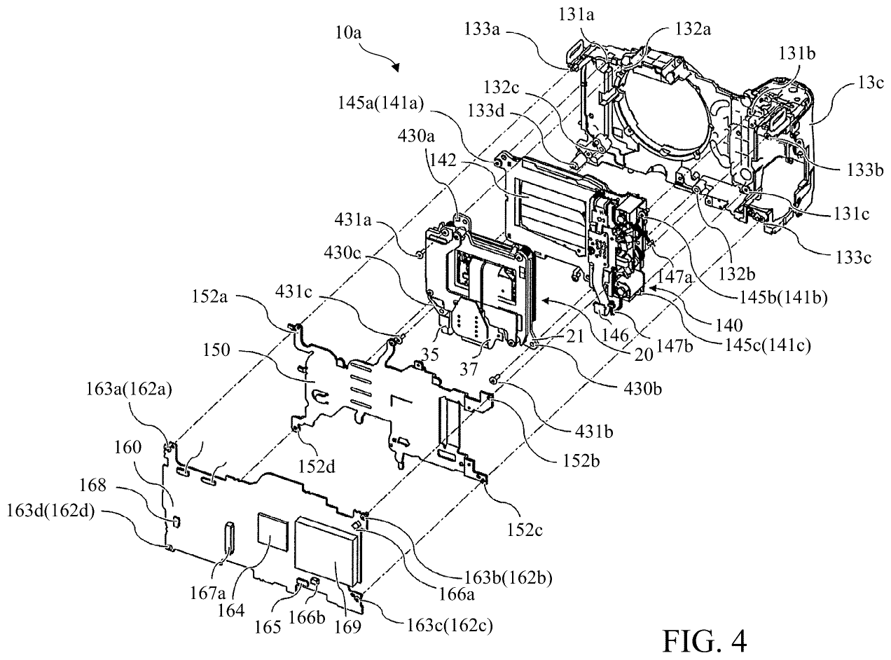

FIG. 4 is an exploded view illustrating the internal structure of the camera 10a when viewed from the rear surface side. The above base member 13c, a shutter member 140, a main frame 150, and a main board 160 are disposed inside the camera 10a. The shutter member 140 opens and closes a shutter opening by driving a shutter curtain 142 to control the exposure amount of the image sensor 11. The shutter member 140 is fixed to the base member 13c when screws 145a, 145b, and 145c inserted into holes 141a, 141b, and 141c provided at its three places are fastened into three first screw hole 131a, 131b, and 131c of the base member 13c.

A fixed member 21 of the sensor image-stabilizing apparatus 20 is formed with holes 430a, 430b, and 430c at positions corresponding to three second screw holes 132a, 132b, and 132c of the base member 13c. The fixed member 21 is fixed to the base member 13c when fixing screws 431a, 431b, and 431c inserted into the holes 430a, 430b, and 430c are fastened into the second screw holes 132a, 132b, and 132c.

The main frame 150 is a plate member formed of metal (such as stainless steel, aluminum, carbon steel, or copper) having high heat conductivity. Holes 152a, 152b, 152c, and 152d are formed at four places of the main frame 150. The main frame 150 has a function to dissipate heat by diffusing heat generated in the camera 10a.

The main board 160 is formed with electronic circuits. Various electronic components such as a CPU 164 and a card connector 169 are mounted on the surface of the main board 160. In addition, a plurality of connectors 165, 166a, 166b, 167a, 167b, 167c, and 168 are mounted on the main board 160. The connectors 167a, 167b, 167c, and 168 are electrically connected to a flexible printed circuit (FPC) 37 connected to the image sensor 11 to transfer imaging signals, and a drive FPC 35 for driving an actuator.

Holes 162a, 162b, 162c, and 162d are formed at four places of the main board 160. Screws 163a, 163b, 163c, and 163d are inserted into the holes 162a to 162d and the holes 152a to 152d of the main frame 150. The main board 160 is fixed to the base member 13c together with the main frame 150 when the screws 163a to 163d are fastened into third screw holes 133a, 133b, 133c, and 133d at four places of the base member 13c. Accordingly, the main frame 150 constitutes the body of the camera 10a together with the base member 13c.

A shutter driving FPC 146 and lead wires 147a and 147b are attached to the shutter member 140 and connected to the connector 165, 166a, and 166b, respectively, of the main board 160. Thereby, signals and power can be transferred between the main board 160 and the shutter member 140.

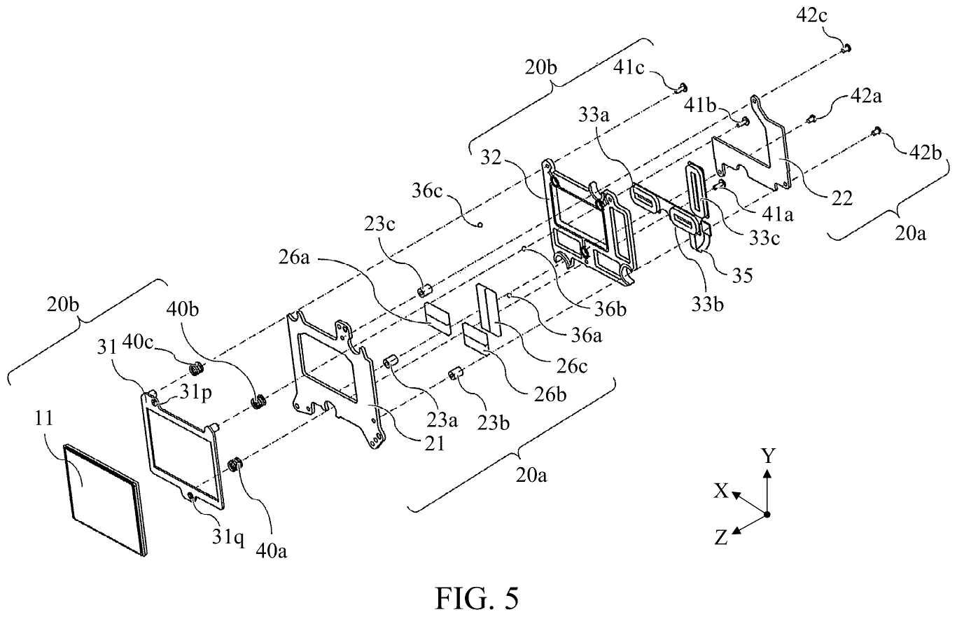

The structure of the sensor image-stabilizing apparatus 20 will be described below in detail. The structure of the lens image-stabilizing apparatus 60 is similar to that of the sensor image-stabilizing apparatus 20. FIG. 5 is an exploded view illustrating the sensor image-stabilizing apparatus 20 when viewed from the front surface side. The sensor image-stabilizing apparatus 20 includes a fixed unit 20a, and a movable unit 20b shiftable and rotatable in the shift plane 12c relative to the fixed unit 20a.

The fixed unit 20a includes the fixed member 21, a rear yoke 22, a first magnet 26a, a second magnet 26b, and a third magnet 26c. Each of the first magnet 26a, the second magnet 26b, and the third magnet 26c is fixed to the fixed member 21 by bonding or the like. The first magnet 26a, the second magnet 26b, and the third magnet 26c each include two magnets magnetized in the optical axis direction and are arranged to generate opposite magnetic fields. However, they may be constituted by using one magnet magnetized with two poles.

The rear yoke 22 is fixed to the fixed member 21 by screws 42a, 42b, and 42c through a first cylindrical member 23a, a second cylindrical member 23b, and a third cylindrical member 23c as spacers (pillar members). The rear yoke 22 is disposed on a side opposite the fixed member 21 across a second movable member 32 in the optical axis direction.

The first magnet 26a and the rear yoke 22 fixed to the fixed member 21 form a first magnetic circuit, and the second magnet 26b and the rear yoke 22 form a second magnetic circuit. The third magnet 26c and the rear yoke 22 form a third magnetic circuit.

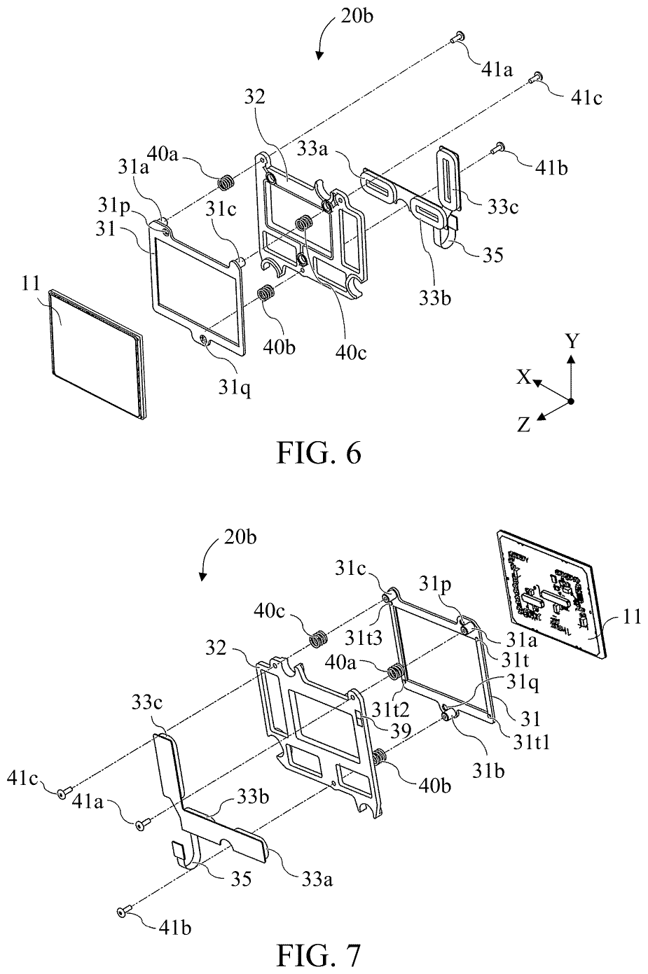

FIGS. 6 and 7 are exploded views illustrating the movable unit 20b when viewed from the front surface side and the rear surface side, respectively. The movable unit 20b includes the image sensor 11, a first movable member 31, and the second movable member 32. The image sensor 11 and fixed to the first movable member 31 by bonding or the like and accordingly held by the first movable member 31. The movable unit 20b also includes a first coil 33a, a second coil 33b, a third coil 33c, and the drive FPC 35 described above. The drive FPC 35 is disposed overlapping the first coil 33a, the second coil 33b, and the third coil 33c when viewed in the optical axis direction and is fixed to the second movable member 32 by bonding or the like. The first movable member 31 and the second movable member 32 are disposed on sides opposite each other across the fixed member 21 in the optical axis direction.

Female screw portions 31a, 31b, and 31c protruding toward the rear surface side are formed at three places of the first movable member 31 holding the image sensor 11. The first movable member 31 is coupled to the second movable member 32 when adjustment screws 41a, 41b, and 41c inserted (held) into holes formed at three places of the second movable member 32 are threaded into the female screw portions 31a, 31b, and 31c. Elastic members 40a, 40b, and 40c such as coil springs are disposed at the outer peripheries of the female screw portions 31a, 31b, and 31c at coupling portions (adjustment spots) at three places where the first movable member 31 and the second movable member 32 are coupled. The elastic members 40a, 40b, and 40c generate a biasing force that acts in a direction of separating the first movable member 31 from the second movable member 32 in the optical axis direction.

The position of the first movable member 31 holding the image sensor 11 can be adjusted relative to the second movable member 32 in the optical axis direction by rotating the adjustment screws 41a, 41b, and 41c relative to the female screw portions 31a, 31b, and 31c. In other words, it is possible to adjust the flange back that is a distance from a mount surface of the mount member 13a to the imaging surface 11a of the image sensor 11. In this manner, an adjusting mechanism includes the female screw portions 31a, 31b, and 31c and the adjustment screws 41a, 41b, and 41c.

The tilt of the first movable member 31 relative to the second movable member 32 can be adjusted by rotating any of the adjustment screws 41a, 41b, and 41c. Thereby, in a case where the image sensor 11 is held by the first movable member 31 with the imaging surface 11a being tilted relative to the shift plane 12c due to manufacturing error, the tilt of the first movable member 31 relative to the second movable member 32 can be adjusted so that the imaging surface 11a becomes parallel to the shift plane 12c.

Spacer members such as washers may be disposed in place of the elastic members 40a, 40b, and 40c at coupling portions of the first movable member 31 and the second movable member 32 so that the flange back and the tilt are adjusted by changing the thicknesses of the spacer members in the optical axis direction. In addition, holes into which the adjustment screws are inserted may be provided to three places of the first movable member 31, and female screw portions into which the adjustment screws are threaded may be provided to the second movable member 32.

As illustrated in FIG. 5, balls 36a, 36b, and 36c as rolling members are disposed at three places between the fixed member 21 and the second movable member 32. The balls 36a, 36b, and 36c have a function to roll to guide the movable unit 20b in a case where the second movable member 32 (the movable unit 20b) shifts relative to the fixed member 21 (fixed unit 20a) (hold spacing between the fixed member 21 and the second movable member 32 in the optical axis direction).

As illustrated in FIG. 7, a magnet 39 is fixed to the second movable member 32 by bonding or the like. The magnet 39 generates a magnetic force (suction force) that acts on the fixed member 21 to move the fixed member 21 closer to the second movable member 32 in the optical axis direction. Thereby, the balls 36a, 36b, and 36c are pressed against the fixed member 21 and the second movable member 32.

The movable unit 20b can freely shift and rotate relative to the fixed unit 20a in the shift plane 12c. Thus, prevention of shift and rotation of the movable unit 20b in the shift plane 12c improves operability in an adjustment process of rotating the adjustment screws 41a, 41b, and 41c. In this embodiment, as illustrated in FIGS. 5 to 7, the first movable member 31 has a positioning hole 31p and an anti-shake hole 31q forming a movement preventing portion that prevents movement (in this example, including shift and rotation) of the movable unit 20b relative to the fixed member 21 in the shift plane 12c. The flange back and the tilt can be adjusted by rotating the adjustment screws 41a, 41b, and 41c in a state in which unillustrated jigs are engaged with the positioning hole 31p and the anti-shake hole 31q to prevent movement of the movable unit 20b in the shift plane 12c.

The movement preventing portion may be provided on the second movable member 32 and may be concave portions or parts of the outer shapes of the first and second movable members instead of holes.

the first magnetic circuit and the first coil 33a form a VCM as a first actuator, the second magnetic circuit and the second coil 33b form a VCM as a second actuator, and the third magnetic circuit and the third coil 33c form a VCM as a third actuator. A Lorentz force is generated in a direction orthogonal to a magnetic field generated in the optical axis direction in the first magnetic circuit and current flowing through the first coil 33a, and the resultant direction of the Lorentz force changes in accordance with the energization direction of the first coil 33a. A similar Lorentz force is also generated with the second magnetic circuit and the second coil 33b and with the third magnetic circuit and the third coil 33c. Driving forces that shift the movable unit 20b in the Y direction are generated by the first and second actuators. A sum of these driving forces generates a driving force in the Y direction, and a difference between these driving forces generates a rotational force about the optical axis. The third actuator generates a driving force that shifts the movable unit 20b in the X direction.

In the sensor image-stabilizing apparatus 20 configured as described above, the fixed unit 20a supports the movable unit 20b with three degrees of freedom so that the movable unit 20b can translate and rotate relative to the fixed unit 20a in the shift plane 12c. Since the image sensor 11 is held by the movable unit 20b, the image sensor 11 can translate and rotate in the shift plane 12c when the fixed unit 20a is fixed to the base member 13c. In other words, the sensor image-stabilizing apparatus 20 is configured as an XYθ stage that can provide three-axis drive control of the image sensor 11.

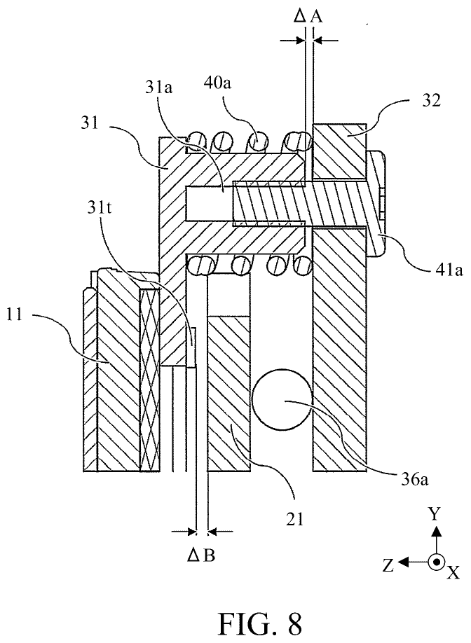

FIG. 8 illustrates a YZ section of a coupling portion where the first movable member 31 and the second movable member 32 in the movable unit 20b are coupled to each other by the adjustment screw 41a through the elastic member 40a. The three coupling portions have the same structure.

The first movable member 31 includes the female screw portion 31a with which the adjustment screw 41a is engaged, and the first movable member 31 is biased so that the first movable member 31 is spaced from the second movable member 32 by a biasing force of the elastic member 40a disposed around the female screw portion 31a. A distance between the first movable member 31 (female screw portion 31a) and the second movable member 32 in the optical axis direction, that is, the flange back from the mount surface to the image sensor 11 can be adjusted by rotating the adjustment screw 41a. A protrusion portion 31t is provided on the rear surface of the first movable member 31 facing the fixed member 21. In a case where an external force exceeding the biasing force of the elastic member 40a acts due to falling of the camera system 10 in the positive Z direction or the like, the protrusion portion 31t contacts the front surface of the fixed member 21, thereby preventing the first movable member 31 and the held image sensor 11 from getting damaged.

In a state in which no external force acts, a gap ΔA between the back end (end on the rear surface side) of the female screw portion 31a of the first movable member 31 and the front surface of the second movable member 32 facing it and a gap ΔB between the back end of the protrusion portion 31t and the front surface of the fixed member 21 have a relationship of ΔA<ΔB. Due to this relationship, in a case where the distance between the first movable member 31 and the second movable member 32 is adjusted by rotating the adjustment screw 41a so that the first movable member 31 becomes closer to the second movable member 32, the protrusion portion 31t can be avoided from interfering with the fixed member 21 while an adjustment margin is secured. As illustrated in FIG. 7, the protrusion portion 31t may be disposed at four corners (31t, 31t1, 31t2, and 31t3) of the first movable member 31 in a quadrilateral frame shape.

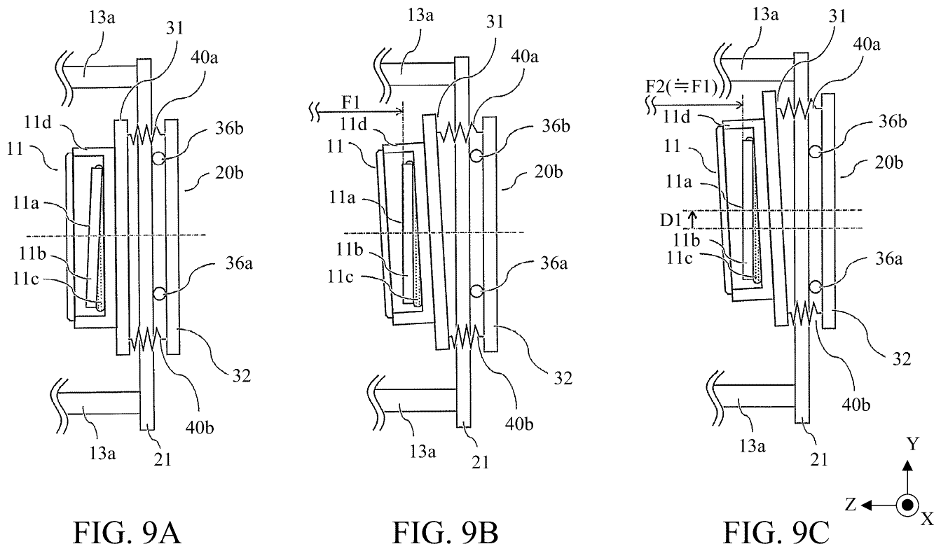

A description will now be given of a change in the flange back in a case where the movable unit 20b shifts in the sensor image-stabilizing apparatus 20. FIGS. 9A to 9C illustrate a YZ section of the fixed member 21 and the movable unit 20b.

FIG. 9A illustrates a state before flange back adjustment. A sensor chip 11b is bonded inside a package 11d of the image sensor 11 by a die bonding member 11c. The surface of the sensor chip 11b is the imaging surface 11a. The imaging surface 11a is tilted relative to the shift plane (XY plane) due to warpage and inclination caused by manufacturing error of the sensor chip 11b.

FIG. 9B illustrates a state in which the imaging surface 11a has become parallel to the shift plane and the flange back is adjusted by tilt adjustment of the first movable member 31. The flange back in this state is denoted by F1.

FIG. 9C illustrates a state in which the movable unit 20b has shifted by D1 in the positive Y direction from the state of FIG. 9B. The flange back in this state is denoted by F2. The movable unit 20b shifts along the fixed member 21 parallel to the shift plane through the balls 36a, 36b, and 36c. Thus, the position of the movable unit 20b in the optical axis direction (Z direction), which has shifted in the positive Y direction, is unlikely to change. In other words, F1 and F2 are approximately equal to each other and change in the flange back due to shift of the movable unit 20b can be minimized. This is similarly applied during rotation of the movable unit 20b.

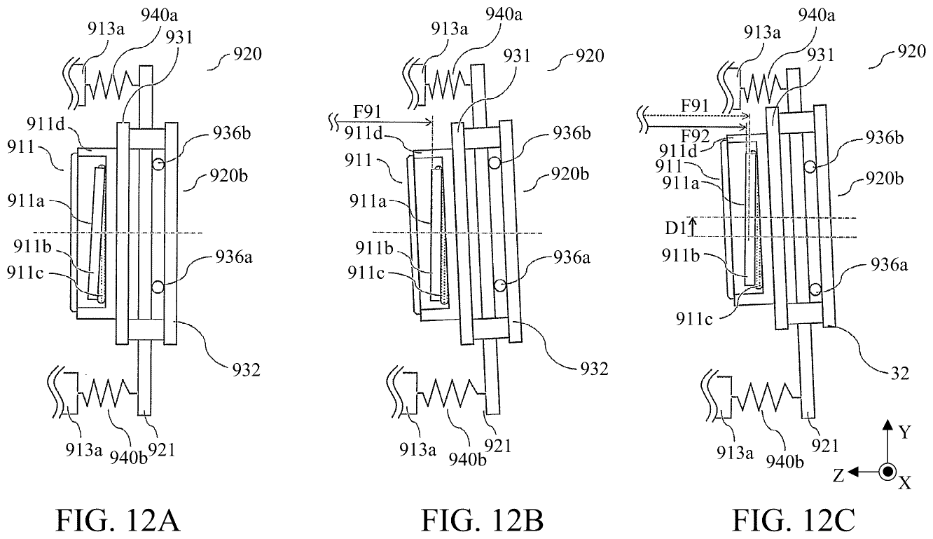

A description will now be given of change in the flange back when a movable unit 920b has shifted in a sensor image-stabilizing apparatus 920 as a comparative example. FIGS. 12A to 12C illustrate a YZ section of a fixed member 921 and the movable unit 920b in the comparative example. In the sensor image-stabilizing apparatus 920, a first movable member 931 and a second movable member 932 are integrated (fixed) so that a distance between them in the optical axis direction cannot be adjusted. The fixed member 921 is coupled to a body 913a of a camera through elastic members 940a and 940b. Flange back adjustment through integrated position adjustment of the fixed member 921 and the movable unit 920b in the optical axis direction, and integrated tilt adjustment relative to the shift plane (XY plane) can be performed by rotating an unillustrated adjustment screw.

FIG. 12A illustrates a state before the flange back adjustment. A sensor chip 911b is bonded inside a package 911d of an image sensor 911 by a die bonding member 911c. The surface of the sensor chip 911b is an imaging surface 911a. The imaging surface 911a is tilted relative to the shift plane due to warpage and inclination caused by manufacturing error of the sensor chip 911b.

FIG. 12B illustrates a state in which the imaging surface 911a has become parallel to the shift plane and the flange back is adjusted by tilt adjustment of the fixed member 921 and the movable unit 920b. The flange back in this state is denoted by F91. Through the tilt adjustment, the fixed member 921 is tilted relative to the shift plane.

FIG. 12C illustrates a state in which the movable unit 920b has shifted by D1 in the positive Y direction from the state of FIG. 12B. The flange back in this state is denoted by F92. In the comparative example, the movable unit 920b shifts along the fixed member 921 tilted to the shift plane through balls 936a and 936b (and an unillustrated ball 936c). As a result, the position of the movable unit 920b in the optical axis direction, which has shifted in the positive Y direction, changes. Accordingly, F91 and F2 are not equal to each other and change in the flange back due to shift of the movable unit 920b is large as compared to this embodiment.

As described above, in this embodiment, the position adjustment of the first movable member 31 holding the image sensor 11 is performed without changing the position of the fixed member 21 during the flange back adjustment. Thus, the size of the sensor image-stabilizing apparatus 20 including the adjusting mechanism and adjustment margin can be reduced as compared to a case where the position adjustment of the entire sensor image-stabilizing apparatus is performed. Moreover, it is possible to suppress change in the position of the imaging surface 11a in the optical axis direction, that is, change in the flange back even if the movable unit 20b is shifted or rotated.

### Second Embodiment

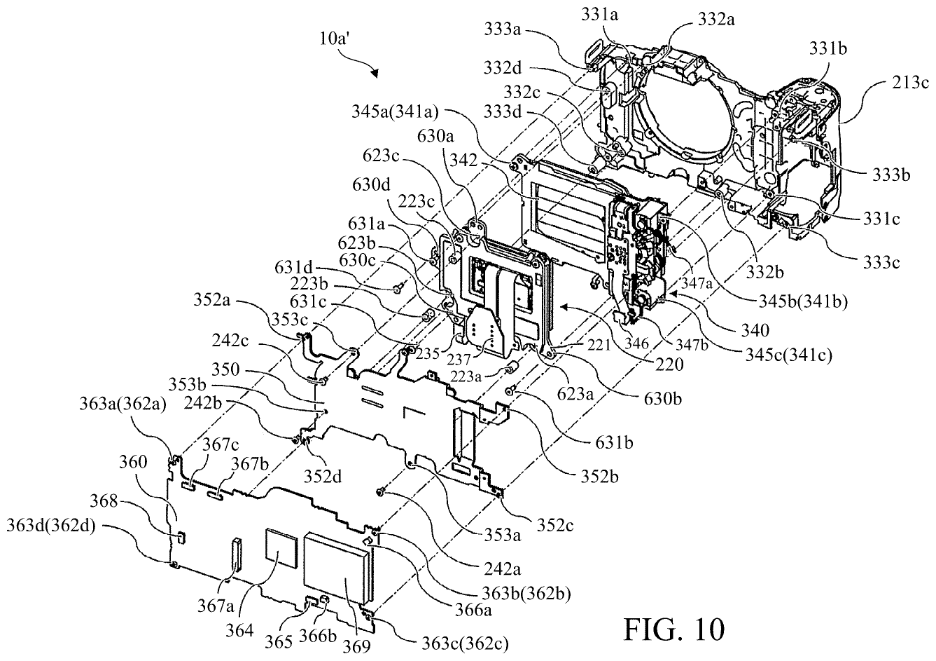

A second embodiment will now be described. FIG. 10 is an exploded view illustrating the internal structure of a camera 10a′ according to the second embodiment when viewed from the rear surface side. This embodiment will discuss a heat dissipating (or radiating) structure of an sensor image-stabilizing apparatus 220. Those elements in this embodiment, which are corresponding elements in the first embodiment, will be denoted by reference numerals made by adding 200 to the corresponding reference numerals in the first embodiment.

A base member 213c, a shutter member 340, a main frame 350, and a main board 360 are disposed inside the camera 10a. The shutter member 340 opens and closes a shutter opening by driving a shutter curtain 342 to control the exposure amount of an image sensor 211. The shutter member 340 is fixed to the base member 13c when screws 345a, 345b, and 345c inserted into holes 341a, 341b, and 341c provided at its three places are fastened into first screw holes 331a, 331b, and 331c provided at three places of the base member 213c.

A fixed member 221 of the sensor image-stabilizing apparatus 220 is formed with holes 630a, 630b, 630c, and 630d at positions corresponding to second screw holes 332a, 332b, 332c, and 332d at four places of the base member 213c. The fixed member 221 is fixed to the base member 213c when fixing screws 631a, 631b, 631c, and 631d inserted into the holes 630a, 630b, 630c, and 630d are fastened into the second screw holes 332a, 332b, 332c, and 332d.

The main frame 350 is a plate member formed of metal (such as stainless steel, aluminum, carbon steel, or copper) having high heat conductivity. Holes 352a, 352b, 352c, and 352d are formed at four places of the main frame 350. The main frame 350 has a function to dissipate heat by diffusing heat generated in the camera 10a′.

The main board 360 is formed with electronic circuits. Various electronic components such as a CPU 364 and a card connector 369 are mounted on the surface of the main board 360. A plurality of connectors 365, 366a, 366b, 367a, 367b, and 368 are mounted on the main board 360. The connectors 367a, 367b, 367c, and 368 are electrically connected to an FPC 237 connected to the image sensor 211 to transfer imaging signals, and a drive FPC 235 for driving an actuator.

Holes 362a, 362b, 362c, and 362d are formed at four places of the main board 360. Screws 363a, 363b, 363c, and 363d are inserted into the holes 362a to 362d and the holes 352a to 352d of the main frame 350. The main board 360 is fixed to the base member 213c together with the main frame 350 when the screws 363a to 363d are fastened into third screw holes 333a, 333b, 333c, and 333d at four places of the base member 213c. Thereby, the main frame 350 constitutes the body of the camera 10a′ together with the base member 213c.

In this embodiment, a first cylindrical member 223a, a second cylindrical member 223b, and a third cylindrical member 223c as heat transfer members are disposed between the main frame 350 and the fixed member 221 of the sensor image-stabilizing apparatus 220. The main frame 150 provided with the first to third cylindrical members 223a to 223c is formed of metal having high heat conductivity. The fixed member 221 is fixed to the main frame 350 when screws 242a, 242b, and 242c inserted into holes 353a, 353b, and 353c of the main frame 350 and the first to third cylindrical members 223a to 223c are fastened into screw holes 623a, 623b, and 623c of the fixed member 221.

A shutter driving FPC 346 and lead wires 347a and 347b are attached to the shutter member 340 and connected to the connectors 365, 366a, and 366b, respectively, of the main board 360. Thereby, signals and power can be transferred between the main board 360 and the shutter member 340.

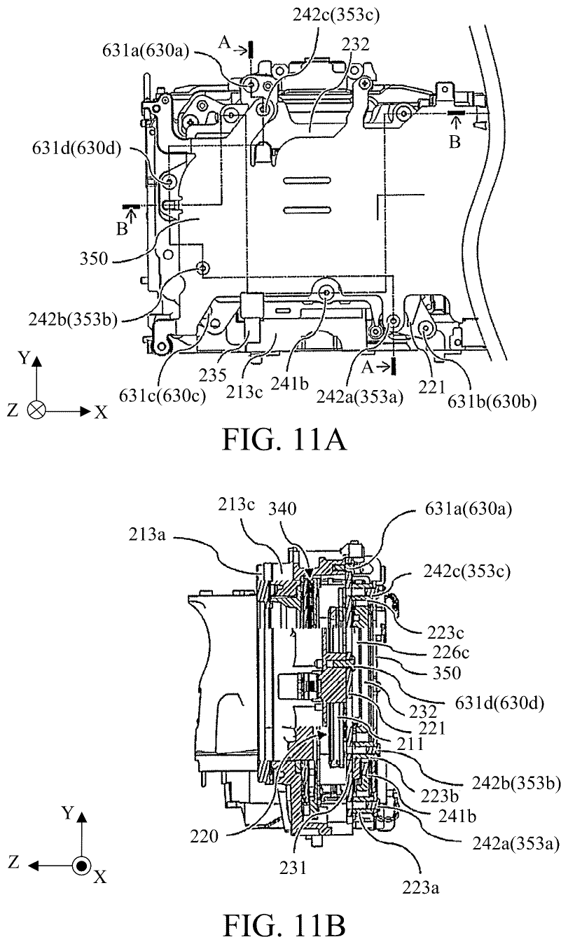

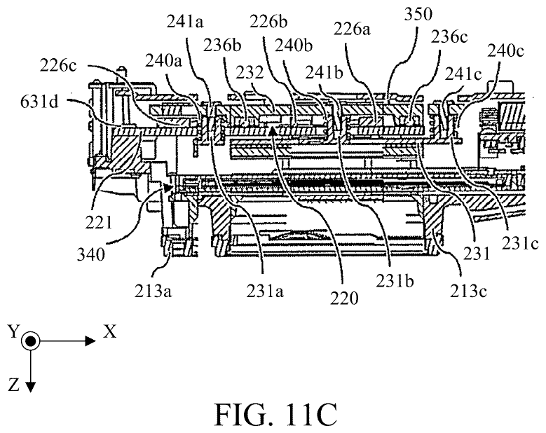

FIG. 11A illustrates a structure on the positive Z side of the main frame 350 when viewed in the rear surface side. FIG. 11B illustrates a section taken along a line A-A in FIG. 11A, and FIG. 11C illustrates a section taken along a line B-B in FIG. 11A. The camera 10a′ may adopt a structure that can efficiently dissipate heat generated by the image sensor 211.

The conventional structure where the flange back adjustment is performed by moving a fixed member and a movable unit as a whole relative to the body of a camera is hard to form a heat dissipating path from a sensor image-stabilizing apparatus to the body. In other words, in the conventional structure, the sensor image-stabilizing apparatus is thermally connected to the body only through the adjustment screws at three places.

On the other hand, in this embodiment, as in the first embodiment, the fixed member 221 of the sensor image-stabilizing apparatus 220 does not move in the flange back adjustment. Thus, a fixing screw 631d can be added, which is the fourth fixing screw in addition to the three fixing screws 631a to 631c that thermally connect the fixed member 221 to the body (base member 213c) as in the conventional structure. In other words, the number of thermal connection places to the base member 213c through the screw fastening can be increased beyond three in the sensor image-stabilizing apparatus 220 according to this embodiment, and accordingly, the number of heat dissipating paths from the sensor image-stabilizing apparatus 220 to the base member 213c can be increased.

Referring now to FIGS. 11B and 11C, a description will be given of a method of fixing the fixed member 221 of the sensor image-stabilizing apparatus 220 to the main frame 350. Since the fixed member 221 does not move in the flange back adjustment, high position accuracy relative to the base member 213c in the Z direction can be achieved. Similarly, high position accuracy relative to the base member 213c in the Z direction can be achieved for the main frame 350, and thus the fixed member 221 can be thermally connected to the main frame 350 through the first to third cylindrical members 223a to 223c and the screws 242a to 242c. Thus, the number of heat dissipating paths from the fixed member 221, which receives heat from the image sensor 211, to the main frame 350 can be increased.

Moreover, since the fixed member 221 does not move relative to the base member 213c in the flange back adjustment, a distance between each of magnets 226a, 226b, and 226c fixed to the fixed member 221 and the main frame 350 in the optical axis direction can be secured with high accuracy. Thus, three magnetic circuits can be formed by the magnets 226a to 226c fixed to the fixed member 221 and a yoke as the main frame 350.

The material of the main frame 350 may be a magnetic material such as carbon steel in a case where the main frame 350 is used as a yoke to form magnetic circuits in this manner. Since the main frame 350 has a heat dissipating function and a yoke function, the number of components of the camera 10a′ and its thickness in the optical axis direction can be reduced.

As described above, this embodiment can increase the number of heat dissipating paths from the sensor image-stabilizing apparatus 220, which includes the image sensor 211 that is a heat generating source, to the body of the camera 10a′, and thereby efficiently dissipate the heat generated in the image sensor 211.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide an optical-element drive apparatus that has a reduced size and small position variation of the optical element in the second direction due to movement of the optical element in the first direction.

This application claims priority to Japanese Patent Application No. 2024-010855, which was filed on Jan. 29, 2024, and which is hereby incorporated by reference herein in its entirety.

What is claimed is:

1. An optical-element drive apparatus comprising:
a fixed member fixed to a body of an optical apparatus;
a movable unit holding an optical element and movable in a first direction relative to the fixed member; and
an actuator configured to drive the movable unit in the first direction relative to the fixed member,
wherein the movable unit includes:
a first movable member holding the optical element,
a second movable member coupled to the first movable member and configured to receive a driving force from the actuator, and
an adjusting mechanism configured to perform position adjustment for the first movable member relative to the second movable member in a second direction orthogonal to the first direction.

2. The optical-element drive apparatus according to claim 1, wherein the adjusting mechanism is held by one of the first movable member and the second movable member, includes an adjustment screw threaded into the other of the first movable member and the second movable member, and performs the position adjustment by rotating the adjustment screw.

3. The optical-element drive apparatus according to claim 2, wherein the adjusting mechanism includes an elastic member disposed between the first movable member and the second movable member.

4. The optical-element drive apparatus according to claim 1, wherein the first movable member and the second movable member are disposed on sides opposite to each other with respect to the fixed member in the second direction.

5. The optical-element drive apparatus according to claim 1,
wherein the actuator includes a magnet and a coil, and
wherein one of the magnet and the coil is held by the fixed member and the other of the magnet and the coil is held by the second movable member.

6. The optical-element drive apparatus according to claim 1, further comprising a rolling member configured to roll along with movement of the movable unit in the first direction and disposed between the fixed member and the first movable member or the second movable member.

7. The optical-element drive apparatus according to claim 1, wherein the movable unit includes a movement preventing portion that prevents movement relative to the fixed member in a surface orthogonal to the second direction in the position adjustment.

8. The optical-element drive apparatus according to claim 1,
wherein the actuator includes a magnet, a coil, and a yoke, and
wherein the yoke fixed to the fixed member is disposed on a side opposite to the fixed member with respect to the second movable member in the second direction.

9. The optical-element drive apparatus according to claim 1,
wherein the adjusting mechanism performs the position adjustment of the first movable member at a plurality of adjustment spots, and
wherein the number of places where the fixed member is fixed to the body is more than the number of adjustment spots.

10. The optical-element drive apparatus according to claim 1, wherein the optical element is an image sensor.

11. An optical apparatus comprising:
an optical-element drive apparatus; and
an optical element,
wherein the optical-element drive apparatus includes:
a fixed member fixed to a body of the optical apparatus;
a movable unit holding the optical element and movable in a first direction relative to the fixed member; and
an actuator configured to drive the movable unit in the first direction relative to the fixed member,
wherein the movable unit includes:
a first movable member holding the optical element,
a second movable member coupled to the first movable member and configured to receive a driving force from the actuator, and
an adjusting mechanism configured to perform position adjustment for the first movable member relative to the second movable member in a second direction orthogonal to the first direction.
